(19) United States
(12) Patent Application Publication
(10) Pub. No.: US 2021/0258742 A1
(43) Pub. Date: Aug. 19, 2021

(54) APPARATUS FOR ESTIMATING NUMBER OF PEOPLE AND METHOD FOR ESTIMATING NUMBER OF PEOPLE

(71) Applicant: NEC Corporation, Tokyo (JP)

(72) Inventors: Jun SAKAI, Tokyo (JP); Toshiki TAKEUCHI, Tokyo (JP); Masao TANIGUCHI, Tokyo (JP)

(73) Assignee: NEC Corporation, Tokyo (JP)

(21) Appl. No.: 17/173,619

(22) Filed: Feb. 11, 2021

(30) Foreign Application Priority Data
Feb. 14, 2020 (JP) 2020-023439

(51) Int. Cl. H04W 4/08; H04L 29/12

(52) U.S. Cl. CPC H04W 4/08; H04W 84/12; H04L 61/2069; H04L 61/6022

(57) ABSTRACT

An apparatus for estimating the number of people according to the present disclosure includes at least one memory configured to store an instruction and at least one processor configured to execute the instruction, the memory and the processor being configured to group signals of terminals acquired within a predetermined time, extract first identifiers of the terminals from the signals included in the group, classify the first identifiers into first identifiers assigned to a global network and those assigned to a local network, count the first identifiers assigned to the global network, and estimate the number of people by using the number of the first identifiers assigned to the global network.

### CROSS REFERENCE TO RELATED APPLICATIONS

This application is based upon and claims the benefit of priority from Japanese patent application No. 2020-023439, filed on February 14, 2020, the disclosure of which is incorporated herein in its entirety by reference.

### TECHNICAL FIELD

The present disclosure relates to an apparatus for estimating the number of people and a method for estimating the number of people.

### BACKGROUND

In recent years, as a method for estimating the number of visitors to an event site, the number of people in a crowd in a shopping mall, or the like, a method for measuring Wi-Fi probe request signals transmitted from smartphones and the like, counting the number of pieces of identification information measured within a set time frame, and estimating the number of people based on the counted number has been proposed.

For example, Japanese Patent No. 6023280 discloses a method for detecting probe request signals transmitted from portable radio terminals and counting the number of identifiers included in the probe request signals detected within a set time. Further, this document also discloses a method for estimating users of a facility by an estimation algorithm using parameters related to the environment around the facility. Note that this document also discloses that MAC (Media Access Control) addresses are used as identifiers and that a period of “10 minutes” is used as an example of the time frame for data within which the number of people is counted.

Further, Japanese Unexamined Patent Application Publication No. 2019-087961 proposes a plurality of methods for protecting the privacy of ordinary users. One of the methods is to verify transmission-source MAC addresses included in probe request signals and track only the terminals to which local addresses are assigned. Note that this document also discloses an example in which unit data is generated by using a time window that slides for each identifier, and a period of “10 seconds to 1 minute” is used as the time window.

In the technique related to the above-described background art, MAC addresses included in probe request signals are used as identifiers. Probe request signals transmitted from a smartphone or the like are intermittently transmitted at intervals of several tens of seconds to several minutes. Therefore, in the technique related to the background art, a certain time frame is set, and the number of people is estimated based on the number of pieces of identification information measured during that period.

However, there is the below-described problem in the method for estimating the number of people in a crowd based on the number detected within a set time while using transmission-source MAC addresses included in probe request signals as identifiers. According to IEEE802.11 standards, a MAC address having a unique and fixed value is assigned to each terminal. In the technique disclosed in Patent Literature 1, the number of people is estimated by counting the number of MAC addresses based on this premise. However, in recent years, there are terminals that use a temporary MAC address assigned to a local network (i.e., a local MAC address) as a transmission-source MAC address that is included in a probe request signal instead of using a true MAC address assigned to a global network (i.e., a global MAC address). According to the research carried out by the inventors of the present application, among such terminals, there are terminals that change their local MAC addresses at intervals of ten-odd seconds (e.g., intervals of about 11 to 19 seconds).

Note that if the set time during which probe request signals are counted is set to a long time, there are cases where the same terminal transmits a plurality of probe request signals including different local MAC addresses during that set time. In this case, the counted number of MAC addresses becomes larger than the number of terminals that are actually present. Meanwhile, there is a method for preventing the same terminal from being counted twice or more by reducing the set time during which probe request signals are counted to, for example, several seconds and thereby making the set time shorter than the interval at which the terminals to be counted change their local MAC addresses. In this case, however, to begin with, probe request signals transmitted from smartphones are intermittently transmitted at intervals of ten-odd seconds to several minutes, so that the possibility that such probe request signals are not transmitted within the set time increases. In this case, the counted number of MAC addresses becomes smaller than the number of terminals that are actually present.

Therefore, although the number of terminals to which global MAC addresses are assigned is correctly counted, there are terminals to which local MAC addresses are assigned and which change the assigned local MAC addresses at certain intervals, so that the number of these terminals is not correctly counted. Therefore, it is difficult to correctly count the actual number of terminals. As a result, there is a problem that it is difficult to accurately estimate the number of people.

### SUMMARY

The present disclosure has been made to solve the above-described problem and an example object thereof is to provide an apparatus for estimating the number of people and a method for estimating the number of people capable of accurately estimating the number of people.

In a first example aspect, an apparatus for estimating the number of people includes at least one memory configured to store an instruction and at least one processor configured to execute the instruction, the memory and the processor being configured to: group signals of terminals acquired within a predetermined time; extract first identifiers of the terminals from the signals included in the group; classify the first identifiers into first identifiers assigned to a global network and those assigned to a local network; count the first identifiers assigned to the global network; and estimate the number of people by using the number of the first identifiers assigned to the global network.

In another example aspect, an apparatus for estimating the number of people includes at least one memory configured to store an instruction and at least one processor configured to execute the instruction, the memory and the processor being configured to: group signals of terminals acquired within a predetermined time; extract unique first identifiers of the terminals from the signals included in the group;

create second identifiers for the signals included in the group by using a plurality of values included in the signals; classify the first identifiers into first identifiers assigned to a global network and those assigned to a local network; count the first identifiers assigned to a global network and unique second identifiers; and estimate the number of terminals having the first identifiers assigned to the local network by using the number of the first identifiers assigned to the global network and the number of the second identifiers, and estimate the number of people by using the number of the first identifiers assigned to the global network and the number of the terminals having the first identifiers assigned to the local network, in which the plurality of values included in the signals are values that are selected in advance as those whose changes within the predetermined time are equal to or smaller than a predetermined value.

In another example aspect, a method for estimating the number of people includes: grouping signals of terminals acquired within a predetermined time; extracting first identifiers of the terminals from the signals included in the group; classifying the first identifiers into first identifiers assigned to a global network and those assigned to a local network; counting the first identifiers assigned to the global network; and estimating the number of people by using the number of the first identifiers assigned to the global network.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram for explaining a configuration of a system for estimating the number of people according to a first example embodiment;

FIG. 2 shows a system configuration for explaining a configuration of a system for estimating the number of people according to a second example embodiment;

FIG. 3 is a block diagram showing a configuration of sensors according to the second example embodiment in a detailed manner;

FIG. 4 is a block diagram showing a configuration of an analysis server according to the second example embodiment in a detailed manner;

FIG. 5 is a graph showing a cumulative frequency distribution of terminals per average interval at which the terminals transmit probe request signals according to the second example embodiment;

FIG. 6 is a graph (an enlarged version) showing a cumulative frequency distribution of terminals 10 per average interval at which the terminals transmit probe request signals according to the second example embodiment;

FIG. 7 is a graph showing the total number of unique MAC addresses per minute and the number of global MAC addresses among them;

FIG. 8 is a classification diagram of a crowd of people in a place of interest which is used by an arithmetic unit of the analysis server according to the second example embodiment in order to estimate the number of people from measurement data;

FIG. 9 is a flowchart showing processes performed by a sensor according to the second example embodiment;

FIG. 10 is a flowchart showing processes performed by the analysis server according to the second example embodiment;

FIG. 11 is a block diagram showing a typical frame format for a management frame;

FIG. 12 is a flowchart showing processes performed by an analysis server according to a third example embodiment;

FIG. 13 is a flowchart showing a method for estimating the number of terminals 10 to which local MAC addresses are assigned, performed by an analysis server 30 according to the third example embodiment;

FIG. 14 is a flowchart showing processes performed by an analysis server 30 according to a fourth example embodiment; and

FIG. 15 is a block diagram showing an example of a hardware configuration of a computer.

### EXEMPLARY EMBODIMENT

Specific example embodiments to which the present disclosure is applied will be described hereinafter in detail with reference to the drawings. In the drawings, the same symbols are assigned to the same components, and redundant descriptions thereof are omitted as appropriate for clarifying the description.

### First Example Embodiment

A first example embodiment according to the present disclosure will be described hereinafter.

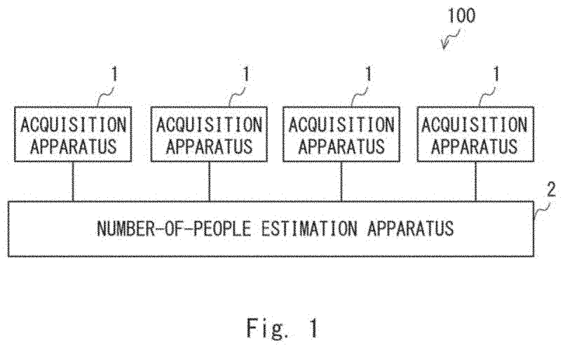

Firstly, a configuration of a system 100 for estimating the number of people (hereinafter also referred to as a number-of-people estimation system 100) according to the first example embodiment will be described with reference to FIG. 1. FIG. 1 is a block diagram showing a configuration of the number-of-people estimation system 100 according to the first example embodiment. The number-of-people estimation system 100 includes acquisition apparatuses 1 and an apparatus 2 for estimating the number of people (hereinafter also referred to as a number-of-people estimation apparatus 2). The acquisition apparatuses 1 acquire signals transmitted from radio terminals. The number-of-people estimation apparatus 2 estimates the number of people by using these signals.

Operations performed by the number-of-people estimation system 100 according to the first example embodiment will be described. Firstly, the acquisition apparatuses 1 acquire signals transmitted from radio terminals. Next, the number-of-people estimation apparatus 2 groups signals acquired within a predetermined time. Next, the number-of-people estimation apparatus 2 extracts identifiers of the terminals from the signals included in the group. The number-of-people estimation apparatus 2 classifies the identifiers into identifiers assigned to a global network and those assigned to a local network. The number-of-people estimation apparatus 2 counts the identifiers assigned to the global network. The number-of-people estimation apparatus 2 estimates the number of people by using the number of identifiers assigned to the global network. Note that the identifiers are, for example, MAC addresses.

Therefore, in the number-of-people estimation system 100 according to the first example embodiment, the number-of-people estimation apparatus 2 can estimate the number of terminals by using the number of identifiers assigned to the global network. As a result, even when there are terminals to which local MAC addresses are assigned and which change the assigned local MAC addresses at certain intervals, it is possible to estimate the number of terminals. Accordingly, it is possible to accurately estimate the number of people in a crowd.

### Second Example Embodiment

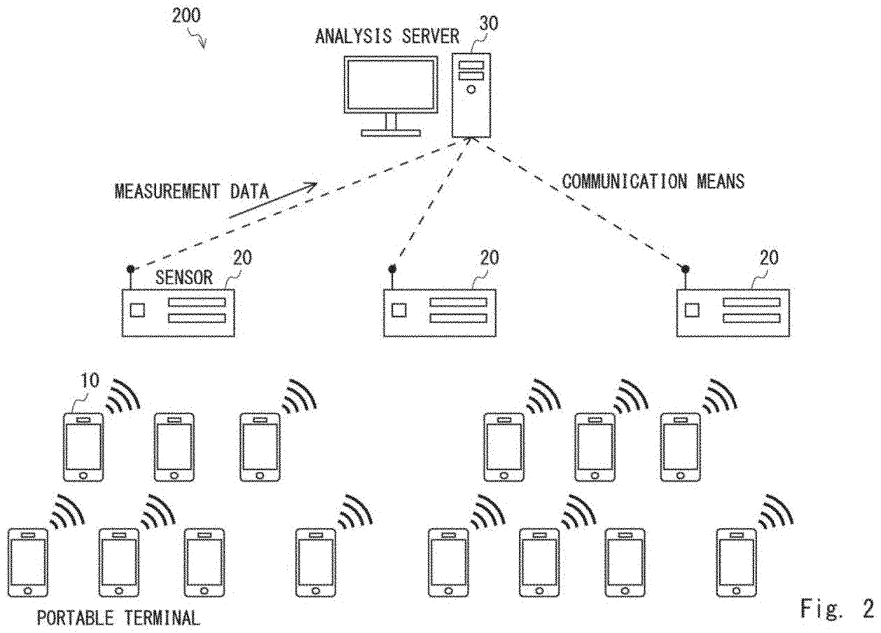

Next, a configuration of a number-of-people estimation system 200 according to a second example embodiment of the present disclosure will be described with reference to FIGS. 2, 3 and 4.

Firstly, a configuration of the number-of-people estimation system 200 according to the second example embodiment will be described with reference to FIG. 2. FIG. 2 shows a system configuration for explaining the configuration of the number-of-people estimation system 200 according to the second example embodiment. The number-of-people estimation system 200 includes terminals 10, sensors 20, and an analysis server 30. Note that the sensors 20 in the second example embodiment correspond to the acquisition apparatuses 1 in the first example embodiment. Further, the analysis server 30 in the second example embodiment corresponds to the number-of-people estimation apparatus 2 in the first example embodiment.

In the number-of-people estimation system 200, the sensors 20 measure radio signals transmitted from the terminals 10 located in a place of interest. Further, the analysis server 30 estimates the number of people in a crowd in the place of interest by analyzing the result of the measurement. Note that the place of interest means a range within which the sensors 20 can measure radio signals transmitted from the terminals 10.

Each of the terminals 10 is, for example, a portable radio terminal having a function of transmitting a radio signal to the sensors 20, and is, for example, a terminal having a Wi-Fi function in conformity with the IEEE802.11 standards such as a smartphone, a tablet-type computer, a notebook PC (Personal Computer), a portable music player, and a portable video game machine for home use. Further, each of the terminals 10 transmits, as the radio signal, a signal such as a probe request signal in conformity with the Wi-Fi standards. The probe request signal includes (i.e., contains) a MAC address. Further, the MAC address can be used as an identifier by which the sensors 20 and the analysis server 30 identify the terminal 10.

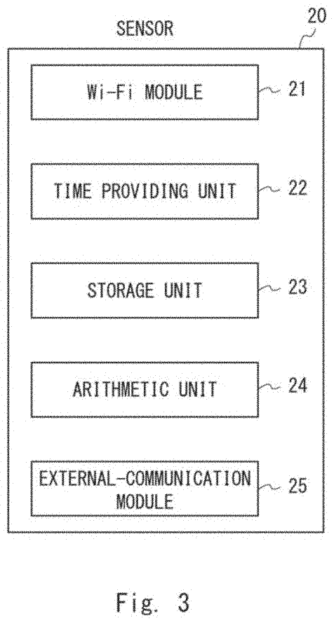

Next, a configuration of the sensor 20 will be described in detail with reference to FIG. 3. FIG. 3 is a block diagram showing the configuration of the sensor 20 according to the second example embodiment in a detailed manner. The sensor 20 is, for example, a general-purpose compact PC. The sensor 20 includes a Wi-Fi module 21, a time providing unit 22, a storage unit 23, an arithmetic unit 24, and an external-communication module 25. The sensor 20 measures signals transmitted from terminals 10 present therearound, and transmits the result of the measurement, to which receiving times are provided (i.e., added), to the analysis server 30. The sensor 20 transmits the measurement result to the analysis server 30 through a wired communication line such as Ethernet (Registered Trademark) or a wireless communication line such as LTE, Wi-Fi, and LPWA.

The Wi-Fi module 21 includes an antenna, a receiver, and a baseband IC (Integrated Circuit), and transmits and receives Wi-Fi signals. For example, the Wi-Fi module 21 measures Wi-Fi signals transmitted from terminals 10 present around the sensor 20. The time providing unit 22 provides (i.e., adds) receiving times to the Wi-Fi signals received by the Wi-Fi module 21.

The storage unit 23 stores the contents of the measured Wi-Fi signals. For example, the storage unit 23 is a storage device such as an HDD (Hard Disk Drive), an SSD (Solid State Drive), or a flash memory. The arithmetic unit 24 estimates the number of people by using the measurement data stored in the storage unit 23. Note that the sensor 20 may not have the configuration of the storage unit 23 and the arithmetic unit 24, and the analysis server 30 (which will be described later) may have the configuration thereof.

The external-communication module 25 includes an Ethernet connection module, a Wi-Fi module, an LTE dongle, and/or the like, and communicates with the analysis server 30.

Note that the Wi-Fi module 21 may be disposed outside the sensor 20 and connected to the sensor 20 through an USB. Further, in the case where the Wi-Fi module 21 wirelessly communicates with the analysis server 30 through a Wi-Fi connection, it is equipped with another Wi-Fi module(s) 21 different from the aforementioned Wi-Fi module 21 for detecting wireless communication with the terminal 10. In this case, the sensor 20 use a plurality of Wi-Fi modules 21, and at least one external Wi-Fi module 21 is connected to the sensor 20 itself through a USB.

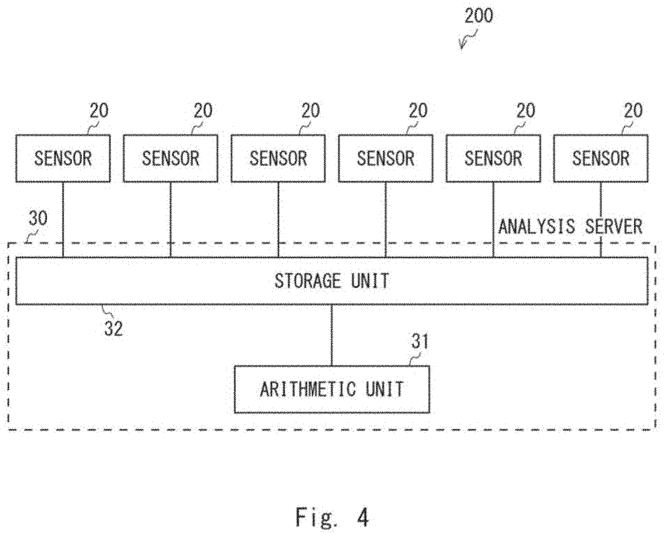

Next, a configuration of the analysis server 30 will be described in detail with reference to FIG. 4. FIG. 4 is a block diagram showing the configuration of the analysis server 30 according to the second example embodiment in a detailed manner. The analysis server 30 includes an arithmetic unit 31 and a storage unit 32. The analysis server 30 has a function of estimating the number of people in a crowd in the place of interest by analyzing the measurement result acquired from the sensors 20.

The storage unit 32 is connected to the sensors 20 and stores the measurement results of the sensors 20. For example, the storage unit 32 is a storage device such as an HDD (Hard Disk Drive), an SSD (Solid State Drive), or a flash memory.

The arithmetic unit 31 estimates the number of people by using the measurement results of the sensors 20 stored in the storage unit 32.

### <Method for Estimating Number of People>

Next, a method for estimating the number of people (hereinafter also referred to as a number-of-people estimating method) by which the arithmetic unit 31 of the analysis server 30 estimates the number of people in a crowd in the place of interest will be described. The inventors of the present application have conducted the below-described experiments to make (i.e., to achieve) the number-of-people estimating method performed by the arithmetic unit 31.

Each terminal 10 in conformity with the Wi-Fi standards transmits a probe request signal to actively detect an access point (AP) present therearound. In many cases, the terminal 10 is configured to automatically transmit this probe request signal without requiring an operation performed by a user. The probe request signal includes (i.e., contains) a MAC address assigned to the terminal 10. Further, the sensor 20 detects probe request signals transmitted from terminals 10 present therearound. Then, the arithmetic unit 31 extracts MAC addresses which are assigned to the terminals 10 and included in the probe request signals, and counts the number of unique MAC addresses. By doing so, the arithmetic unit 31 estimates the number of terminals 10 present around the sensor 20.

Note that the frequency at which a terminal 10 transmits a probe request signal to the sensor 20 (i.e., how often a terminal 10 transmits a probe request signal to the sensor 20) changes depending on the type and the setting of the terminal 10. In order to examine this frequency of transmission operations, the inventors of the present application have conducted the following experiment.

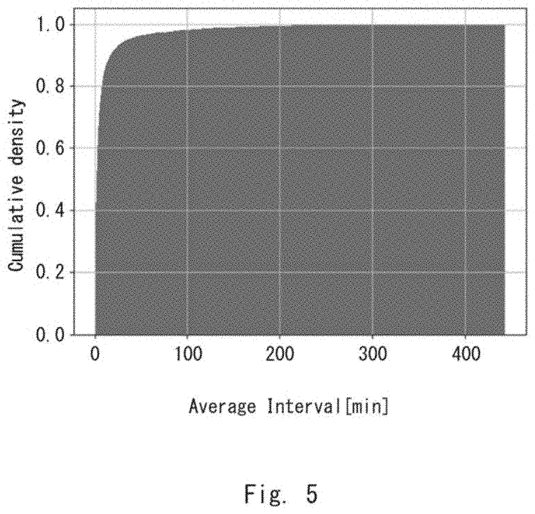

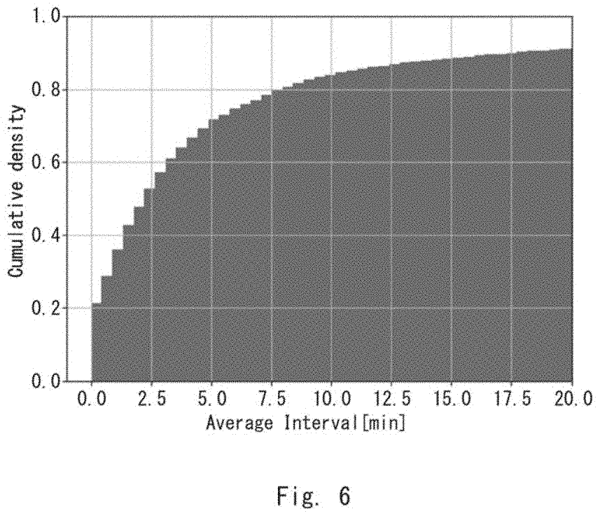

Firstly, in a state in which people who helped the experiment possessed 3,000 terminals 10, the inventors of the present application measured probe request signals transmitted from these terminals 10 for eight hours by using sensors 20. Then, the inventors of the present application calculated, for each MAC address included in the measurement result, an average interval at which the terminal 10 transmits a probe request signal, and calculated a cumulative frequency distribution. FIGS. 5 and 6 show the results of the calculation. FIG. 5 is a graph showing a cumulative frequency distribution of terminals 10 per average interval at which the terminals 10 transmit probe request signals according to the second example embodiment. FIG. 6 is a graph (an enlarged version) showing a cumulative frequency distribution of terminals 10 per average interval at which the terminals 10 transmit probe request signals.

As shown in FIGS. 5 and 6, the number of terminals 10 that transmit signals at an interval of two minutes or shorter is about 50% to the total number of terminals 10, and the number of terminals that transmit signals at an interval of 10 minutes or shorter is about 85% to the total number. Note that if the time frame within which the analysis server 30 counts probe request signals is several seconds to several tens of seconds, the number of probe request signals that the analysis server 30 misses to count increases. As a result, the number of unrecognized (i.e., uncounted) terminals 10 increases, and hence the analysis server 30 cannot correctly estimate the number of people. Therefore, in order to enable the analysis server 30 to accurately estimate the number of people, it is important that the time frame within which probe request signals are counted in the analysis server 30 should be set to a sufficiently long time, and by doing so the number of probe request signals that are missed to be counted should be reduced.

However, if the time frame within which probe request signals are counted in the arithmetic unit 31 is set to a long time, terminals 10 to which MAC addresses are locally assigned and which change these MAC address at arbitrary timings appear. As a result, there is a possibility that the number of MAC addresses that the arithmetic unit 31 counts becomes larger than the actual number of terminals. This possibility will be described hereinafter in a concrete manner.

A MAC address is a 48-bit identifier assigned to a communication module in conformity with the IEEE802.11 standards. In the case where one octet includes eight bits, a MAC address is expressed by six octets. Further, the higher-order three octets of a MAC address constitute a unique identifier that is assigned on a manufacturer-by-manufacture basis, and are called an OUI (Organizationally Unique Identifier) or a vendor code.

A unique and fixed MAC address is assigned to each terminal. Such a MAC address is used in the global network (hereinafter also referred to as a global MAC address). Meanwhile, when MAC addresses are used in a local network, in some cases, temporary MAC addresses (local MAC addresses) are assigned to terminals 10. Local MAC addresses are used in a multi-SSID (Service Set Identifier) AP, are used when a portable radio terminal is used through tethering, and are used in PSP (peer-to-peer) communication or the like.

In a local MAC address, the seventh bit of the first octet has a value “1”. Meanwhile, in a global MAC address, the seventh bit of the first octet has a value “0”. Therefore, it is determined whether a MAC address included in a probe request signal is a local MAC address or a global MAC address based on the above-described difference.

Note that a certain number of terminals 10 use local MAC addresses as the MAC addresses that are assigned to the terminals 10 themselves and included in their probe request signals. Further, a certain number of terminals 10 change their local MAC addresses at arbitrary timings. Therefore, if the time frame within which probe request signals are counted in the arithmetic unit 31 is long, there is a possibility that the number of MAC addresses that the arithmetic unit 31 counts becomes larger than the actual number of terminals.

In order to verify this possibility, the inventors of the present application have conducted the following three types of experiments, i.e., Experiments 1 to 3. In these experiments, 200 people who helped the experiments possessed terminals 10, and sensors 20 are arranged in the vicinity of these people. Then, the sensors 20 detected probe request signals transmitted from the terminals 10. Further, the MAC addresses of the terminals 10 included in the probe request signals thereof were counted. Note that, in the experiments, the MAC addresses of the terminals 10 included in the probe request signals thereof included both local MAC addresses and global MAC addresses. In the Experiment 1, the people who helped the experiment (hereinafter also referred to as helpers) operated the terminals 10 as they desired. In the Experiment 2, the helpers did not operate the terminals 10. In the Experiment 3, the helpers repeated operations in which they turned on and off the Wi-Fi function of the terminals 10 at intervals of several seconds.

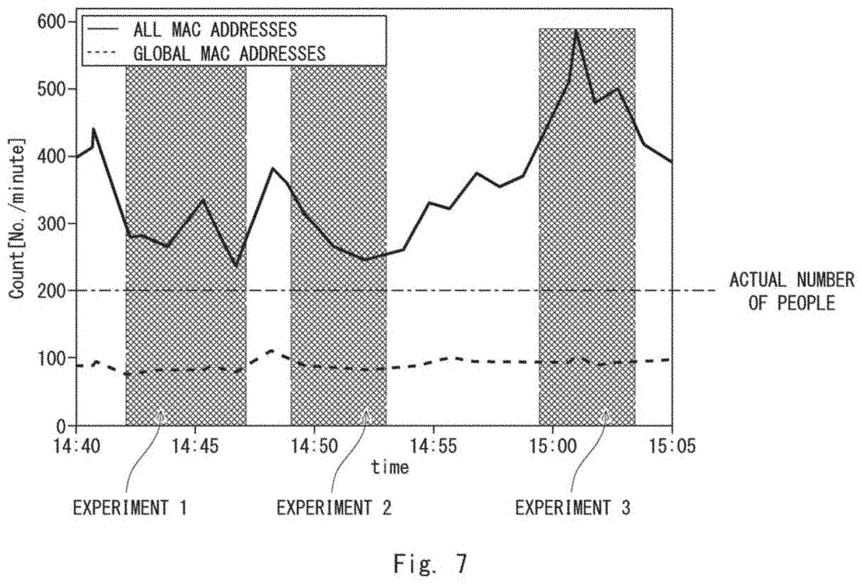

The results of these experiments will be described with reference to FIG. 7. FIG. 7 is a graph showing the total number of unique MAC addresses per minute and the number of global MAC addresses among them. Note that, in consideration of the possibility that there are terminals that do not transmit a probe request signal at all within one minute, the total number of MAC addresses indicated by a solid line should ideally be smaller than 200.

However, as shown in FIG. 6, the total number of MAC addresses (local MAC addresses+global MAC addresses) assigned to terminals 10 indicated by the solid line changes between 250 and 600. That is, the estimated number of terminals is much larger than the actual number of terminals. Meanwhile, the number of global MAC addresses assigned to terminals 10 indicated by a dotted line changes around 100. Based on the presumption that there were terminals 10 that did not transmit a probe request signal at all within one minute, it is estimated that global MAC addresses were assigned to one hundred and several tens of terminals 10 (e.g., to about 110 to 190 terminals 10). Further, it is also estimated that local MAC addresses were assigned to the remaining several tens of terminals. Therefore, this means that the several tens of terminals that transmitted probe request signals including local MAC addresses changed their MAC addresses at a frequency of several times to ten-odd times (e.g., several times to about 11-19 times) per minute according to the operation states.

If the arithmetic unit 31 estimates the number of terminals or the number of people by using the number of unique MAC addresses detected by the sensors 20 as it is, the number of people estimated by the arithmetic unit 31 becomes much larger than the actual number of people. Further, in the above-described experiments, MAC addresses were counted in the time frame of one minute, and the estimated number of people increases as this time frame becomes longer.

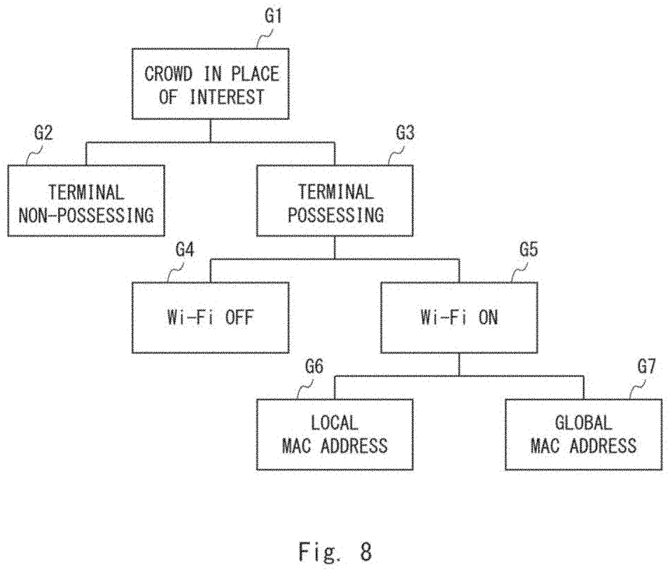

Here, in order to enable the arithmetic unit 31 to estimate the number of people in a crowd present in the place of interest, these people are classified (i.e., divided into groups) as shown in FIG. 8. FIG. 8 is a classification diagram of a crowd of people in a place of interest which is used by the arithmetic unit 31 of the analysis server 30 according to the second example embodiment in order to estimate the number of people from measurement data. Firstly, a crowd G1 of people present in the place of interest are classified into people who do not possess terminals 10 (a terminal non-possessing group G2) and people who possess terminals 10 (a terminal possessing group G3). Next, the terminals 10 possessed by the people included in the terminal possessing group G3 are classified into terminals 10 in which the Wi-Fi function is in an Off-state (a Wi-Fi-Off group G4) and terminals 10 in which the Wi-Fi function is in an On-state (a Wi-Fi-On group G5). Further, the terminals 10 in the Wi-Fi-On group G5 are classified into terminals 10 to which local MAC addresses are assigned (a local MAC address group G6) and terminals 10 to which global MAC addresses are assigned (a global MAC address group G7).

Therefore, the arithmetic unit 31 counts the number of unique global MAC addresses among the MAC addresses assigned to the terminals 10, and estimates the number of people in the crowd G1 present in the place of interest according to the below-shown Expression 1 by using the counted number of unique global MAC addresses. Note that in each of terminals 10, one MAC address assigned to itself is included (i.e., contained) in its probe request signal. Therefore, the number of unique global MAC addresses can be regarded as the number of terminals included in the global MAC address group G7. In the Expression 1, N is the number of people in the crowd G1 present in the place of interest, which is the number to be estimated. A parameter rₚ is a ratio of the number of people included in the terminal possessing group G3 to the number of people in the crowd G1 present in the place of interest. A parameter rₒₙ is a ratio of the number of terminals possessed by people included in the Wi-Fi-On group G5 to the number of terminals possessed by people included in the terminal possessing group G3. A parameter r_{G} is a ratio of the number of terminals included in the global MAC address group G7 to the number of terminals included in the Wi-Fi-On group G5. A parameter M_{G} is the number of unique global MAC addresses assigned to terminals 10.

$$N = \frac{1}{{r}_{p} \times {r}_{on} \times {r}_{G}} {M}_{G} \qquad [ Expression 1 ]$$

The aforementioned parameters rₚ, rₒₙ and r_{G} may be determined in advance. For example, the parameter rₚ is a value such as 94.8%, which is a statistical value indicating the ownership states of information and communication apparatuses published by the Ministry of Internal Affairs and Communications. Based on the result of the experiment shown in FIG. 7, the values of rₒₙ and r_{G} are, for example, 90% and 55%, respectively. Note that the parameters rₚ, rₒₙ and r_{G} may be values that are experimentally obtained by comparing numbers counted by a camera(s) or manually counted with the result of measurement carried out by the number-of-people estimation system 200 according to this example embodiment.

Further, these parameters are preferably set according to the properties of the place(s) where the sensors are installed. For example, statistical data about the ratio of people who possess portable radio terminals which is shown on a prefecture-by-prefecture basis has been published. Therefore, these parameters are set according to the region where the sensors are installed. Further, the possession rate of portable radio terminals also changes according to the age, and it is presumed that the possession rate is low for infants, elementary school children, and elderly people.

For example, in the case where the place where the sensors are installed is in an event where children are gathered, or in a place or a region where the ratio of elderly people is high such as in a bus on a weekday or in a hospital, a small value is set to the parameter rₚ. Further, when the sensors are installed in a hotel, a conference hall, or a place where the ratio of people who are actually using portable radio apparatuses is high, the parameter rₒₙ is increased. Further, when the place where the sensors are installed is a place where the ratio of people who are performing Wi-Fi communication is high, the ratio of people who are transmitting data signals rather than the probe request signals increases, so that the parameter r_{G} is increased. As described above, various values are set to the parameters in the Expression 1 according to the region, the place, and the time.

Note that the arithmetic unit 31 practically estimates the sum total of the number of terminals 10 having global MAC addresses and those having local MAC addresses by using the number of the global MAC addresses and predetermined parameters. Note that when the number of terminals 10 having local MAC addresses is represented by M_{L}, the number of people included in the group in which the Wi-Fi function is in an On-state (i.e., the Wi-Fi-On group G5), which is represented by the rightmost term in the Expression 1, can be transformed into the below-shown Expression 2.

$$\frac{1}{{r}_{G}} {M}_{G} = {M}_{G} + {M}_{L} \qquad [ Expression 2 ]$$

Therefore, the number M_{L} is obtained by the below-shown Expression 3.

$${M}_{L} = ( \frac{1}{{r}_{G}} - 1 ) {M}_{G} \qquad [ Expression 3 ]$$

### <Process for Estimating Number of People>

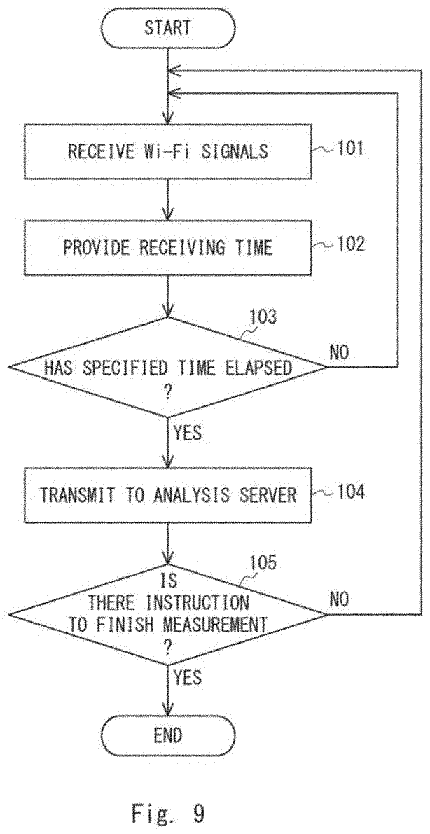

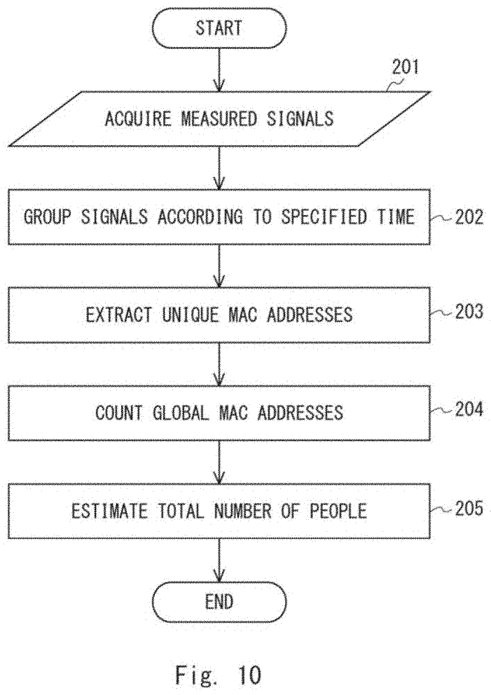

Next, processes performed by the number-of-people estimation system 200 according to the second example embodiment will be described with reference to FIGS. 9 and 10.

Firstly, a flow of processes in which the sensor 20 measures a signal transmitted from a Wi-Fi terminal present in a place of interest will be described with reference to FIG. 9. FIG. 9 is a flowchart showing processes performed by the sensor 20 according to the second example embodiment.

The Wi-Fi module 21 of the sensor 20 receives a Wi-Fi signal of a terminal 10 (S101). Specifically, upon receiving an instruction to start measurement from the analysis server 30, the Wi-Fi module 21 measures a Wi-Fi signal typified by a probe request signal. Next, the time providing unit 22 of the sensor 20 provides (i.e., adds) a receiving time to the measured Wi-Fi signal of the terminal 10 (S102). The sensor 20 continues the processes in the steps S101 and S102 until a predetermined time has elapsed.

Next, when the predetermined time has elapsed (S 103 YES), the external-communication module 25 of the sensor 20 sends the result of the measurement to the analysis server 30 (S 104). This measurement result is stored in the storage unit 32 of the analysis server 30. Then, when there is an instruction to finish the measurement from the analysis server 30 (S105 YES), the sensor 20 finishes the series of processes. Further, when there is no instruction to finish the measurement from the analysis server 30 (S105 NO), the sensor 20 performs the process in the step S101. On the other hand, when the predetermined time has not elapsed yet (S103 NO), the sensor 20 performs the process in the step S101.

Next, processes for estimating the number of people performed by the analysis server 30 will be described with reference to FIG. 10. FIG. 10 is a flowchart showing processes performed by the analysis server 30 according to the second example embodiment.

Firstly, the arithmetic unit 31 of the analysis server 30 acquires signals which were measured by the sensors 20 and are stored in the storage unit 32 (S201). Next, these signals are grouped according to the specified time (S202). According to the result of the above-described experiment (FIG. 6), in the case where the specified time frame is, for example, 10 minutes, the sensors 20 can receive the probe request signals of 82% of all the terminals. Further, in the case where the sensors 20 are installed in a place where the movements of people are fierce, the specified time frame can be set to about one minute.

Next, the arithmetic unit 31 extracts unique MAC addresses assigned to terminals 10 for each of the groups which have been formed according to the time (S203). Next, the arithmetic unit 31 analyzes these unique MAC addresses, extracts global MAC addresses, and counts the number of the extracted global MAC addresses (S204). Lastly, the arithmetic unit 31 estimates the total number of people by using the counted number (S205). Note that the arithmetic unit 31 can estimate the total number of people from the number of global MAC addresses according to the Expression 1. Note that the arithmetic unit 31 may estimate the total number of people by estimating the number of local MAC addresses according to the Expression 2.

As described above, in the number-of-people estimation system 200 according to the second example embodiment, the arithmetic unit 31 of the analysis server 30 summarizes (i.e., collects) probe request signals from the signals measured by the sensors 20. Then, the arithmetic unit 31 extracts signals in which the MAC addresses are global MAC addresses by referring to information contained in the probe request signals, and counts the number of unique global MAC addresses. Then, the arithmetic unit 31 estimates the total number of people according to the Expression 1 based on the counted number.

Note that, in the number-of-people estimation system 200 according to the second example embodiment, the arithmetic unit 31 can estimate the number of terminals 10 to which local MAC address are assigned according to the Expression 1 by using global MAC addresses. Therefore, even when there are terminals to which local MAC addresses assigned and which change the assigned local MAC addresses at certain intervals, it is possible to estimate the number of terminals. Accordingly, it is possible to accurately estimate the number of people in a crowd.

Note that, in actual operations, identifiers in acquired data are anonymized for the sake of privacy protection. That is, MAC addresses assigned to terminals 10 included in the measurement result acquired by the sensors 20 are anonymized by using a one-way hashing function. Therefore, the sensor 20 discards original MAC addresses included in the measurement result and replaces them with anonymized MAC addresses. Specifically, before the hashing, the sensor 20 analyzes a MAC address as to whether it is a global MAC address or a local MAC address, and extracts its flag. Then, for example, the sensor 20 assigns a value “0” when the MAC address is a global MAC address and assigns a value “1” when the MAC address is a local MAC address. Further, the sensor 20 stores this assigned value together with the anonymized MAC address. This anonymization is performed by the sensor 20 when it receives the data, and is preferably performed after the step of providing a receiving time in FIG. 9 (S102). Note that the analysis server 30, instead of the sensor 20, may perform the above-described anonymization.

Further, the number-of-people estimation system 200 according to the second example embodiment is described by using a terminal having a Wi-Fi function in conformity with the IEEE802.11 standards as an example of the terminal 10. However, the application of the present disclosure is not limited to such terminals. For example, in the case of a portable telephone terminal used in a public network, the terminal has a terminal identifier such as an IMEI (International Mobile Equipment Identity) that is assigned on a terminal-by-terminal basis and an IMSI (User Identity Module) assigned to a USIM (International Mobile Subscriber Identity) card. Therefore, it is possible to estimate the number of people in a similar manner by using such identifiers. Alternatively, in the case of Bluetooth (Registered Trademark), it is possible to estimate the number of people in a similar manner by using Device Ids which are identifiers of devices.

Further, in the number-of-people estimation system 200 according to the second example embodiment, the sensor 20 transmits received signals of terminals 10 to the analysis server 30, and the arithmetic unit 31 of the analysis server 30 estimates the number of people. Instead of using such a configuration, it is possible to configure the system so that, in each of a plurality of sensors 20, the arithmetic unit 24 of the sensor 20 estimates the number of people based on signals of terminals 10 which that sensor 20 has received.

### Third Example Embodiment

Next, a configuration of a number-of-people estimation system 300 and operations performed thereby according to a third example embodiment of the present disclosure will be described. The configuration of the number-of-people estimation system 300 is identical to that of the number-of-people estimation system 200 according to the second example embodiment. However, regarding the operations performed by the number-of-people estimation system 300, the method and the process for estimating the number of people performed by the arithmetic unit 31 of the analysis server 30 are different from those of the number-of-people estimation system 200.

### <Method for Estimating Number of People>

As shown in FIG. 8, the arithmetic unit 31 of the analysis server 30 of the number-of-people estimation system 200 according to the second example embodiment estimates the number of people in the crowd G1 in the place of interest from the number of global MAC addresses assigned to terminals 10.

In contrast to this, the arithmetic unit 31 of the analysis server 30 of the number-of-people estimation system 300 according to this example embodiment estimates the number of terminals included in the local MAC address group G6 as shown in FIG. 8. Further, the arithmetic unit 31 estimates the number of terminals in the Wi-Fi-On group G5 by adding the above-described estimated number to the number of terminals included in the global MAC address group G7. The arithmetic unit 31 estimates the number of people in the crowd G1 in the place of interest according to the below-shown Expression 5 that is obtained by transforming the Expression 1. A method for estimating the number of people performed by the arithmetic unit 31 of the analysis server 30 of the number-of-people estimation system 300 will be described hereinafter.

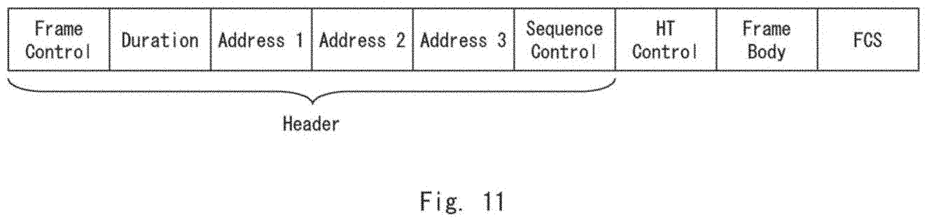

Frames based on the IEEE802.11 standards typified by the Wi-Fi include various types of frames such as a control frame, a management frame, and a data frame. Among these frames, the uses of the management frame include, in addition to the probe request, various types of uses such as a probe response, a beacon, an association request, an association response, an association cancellation, authentication, and an authentication cancellation. A format for data is defined for each of these uses. FIG. 11 shows a typical frame format for the management frame. FIG. 11 is a block diagram showing a typical frame format for the management frame. The management frame includes fields of a Frame Control, a Duration, an Address, Sequence Control, HT Control, a Frame Body, and an FCS (Frame Check Sequence).

As shown in FIG. 11, the Frame Control includes various types of information such as a type of the frame, a destination of the frame, whether the transmission source is wireless or wired, fragment information, power management, and whether WEP is used. The Duration is information about a scheduled period during which radio waves are used (i.e., a time required to transmit the frame). The Address is information about a MAC address at the destination, a MAC address at the transmission source, a MAC address of an access point (such as a BSSID), and the like. The Sequence Control is information about a sequence number of data to be transmitted, or a fragment number when data is fragmented. The HT Control includes information about, for example, calibration of a Position and a sequence. Note that the HT Control may or may not be included in the management frame. In the Frame Body, a field that is configured according to the type of the management frame is defined. Note that the management frame used in the probe request includes 14 types of fields such as an SSID, Supported Rates, and Request information.

It should be noted that some of these fields are useful for identifying terminals of the transmission source, while others of them are not useful for the identification. Examples of the fields that are not useful for the identification include the type of the frame and the fragment information included in the Frame Control, the Duration, the Sequence Control, and the Channel Usage included in the Frame Body. Their values change in a short time, and they are transmitted at the same time but with values that change according to the purpose. In contrast, the values of transmission-source information, power management, and WEP information included in the Frame Control, the SSID and the Supported rate of the Frame Body, and the like do not change in a short time, so they are useful, to some extent, for classifying and identifying terminals of the transmission source.

Therefore, the arithmetic unit 31 of the analysis server 30 of the number-of-people estimation system 300 connects the values of these frames useful for the identification and uses the combined value as an identifier of the terminal 10. This identifier is referred to as a device-type identifier. Even when the MAC address is changed in a short time in a terminal 10 to which a local MAC address is assigned, the device-type identifier thereof does not change unless the setting of the terminal is changed. Therefore, by selecting appropriate fields, the device-type identifier becomes effective for estimating the number of terminals.

However, in many cases, the device-type identifiers of portable radio terminals of the same device type are identical to each other when their settings are the same as each other. According to the inventors' examination, about three terminals have the same device-type identifier on average. Therefore, the arithmetic unit 31 defines the ratio of terminals having the same device-type identifier as an overlapping ratio a, and estimates this overlapping ratio a according to the below-shown Expression 4. In the Expression 4, M is the number of unique MAC addresses assigned to detected terminals 10, and T is the number of unique device-type identifiers. The overlapping ratio a tends to increase as the number of terminals to be detected increases. For example, when the number M is several tens, the overlapping ratio a is about 1.2, and whereas when the number M is several thousands, the overlapping ratio a is about 5.0.

$$α = \frac{M}{T} \qquad [ Expression 4 ]$$

Note that the arithmetic unit 31 estimates the number M_{L} of unique local MAC addresses assigned to terminals 10 by using the above-described overlapping ratio a. A method for estimating the number M_{L} of terminals 10 to which local MAC addresses are assigned will be described hereinafter.

An overlapping ratio a_{L} of terminals 10 to which local MAC addresses are assigned is expressed by the below-shown Expression 5. The number M_{L} is the number of unique local MAC addresses assigned to terminals 10. The number T_{L} is the number of device-type identifiers in terminals 10 to which local MAC addresses are assigned.

$${a}_{L} = \frac{{M}_{L}}{{T}_{L}} \qquad [ Expression 5 ]$$

Further, an overlapping ratio a_{G} of terminals whose MAC addresses are global MAC addresses is expressed by the below-shown Expression 6. The number M_{G} is the number of unique global MAC addresses assigned to terminals 10. The number T_{G} is the number of device-type identifiers in terminals 10 to which global MAC addresses are assigned.

$${a}_{G} = \frac{{M}_{G}}{{T}_{G}} \qquad [ Expression 6 ]$$

Note that although the arithmetic unit 31 can calculate the numbers M_{G}, T_{G} and T_{L} from the signals transmitted from the terminals 10, the arithmetic unit 31 cannot calculate the number M_{L}. Therefore, the arithmetic unit 31 assumes that the overlapping ratio a_{L} is nearly equal to the overlapping ration a_{G} (a_{L}≈a_{G}), and calculates the number M_{L} according to the below-shown Expression 7.

M_{L}=a_{L}T_{L}≈a_{G}T_{L} [Expression 7]

Then, the number N of people in the crowd G1 in the place of interest, which is to be estimated, is expressed by the below-shown Expression 8 that is obtained by transforming the Expression 1. In the expression, the parameter rₚ is a ratio of the number of people included in the terminal possessing group G3 to the number of people in the crowd G1 in the place of interest. The parameter rₒₙ is a ratio of the number of terminals possessed by people included in the Wi-Fi-On group G5 to the number of terminals possessed by people included in the terminal possessing group G3.

$$N = \frac{1}{{r}_{p} \times {r}_{on}} ( {M}_{G} + {M}_{L} ) \qquad [ Expression 8 ]$$

The arithmetic unit 31 estimates the number N of people in the crowd G1 in the place of interest according to the Expression 8. Specifically, the number M_{L} indicates the number of terminals included in the local MAC address group G6. The number M_{G} indicates the number of terminals included in the global MAC address group G7. Further, the arithmetic unit 31 estimates the number of terminals in the Wi-Fi-On groups G5 by adding the value of M_{G} to the value of M_{L}. The arithmetic unit 31 estimates the number N of people in the crowd G1 in the place of interest by dividing the obtained value by the parameters rₚ and rₒₙ.

### <Process for Estimating Number of People>

Next, a process for estimating the number of people will be described. Similarly to the number-of-people estimation system 200, the sensor 20 of the number-of-people estimation system 300 according to the third example embodiment performs a process for measuring signals transmitted from terminals 10 present therearound and transmitting the measured signals to the analysis server 30. Therefore, the description of this process is omitted.

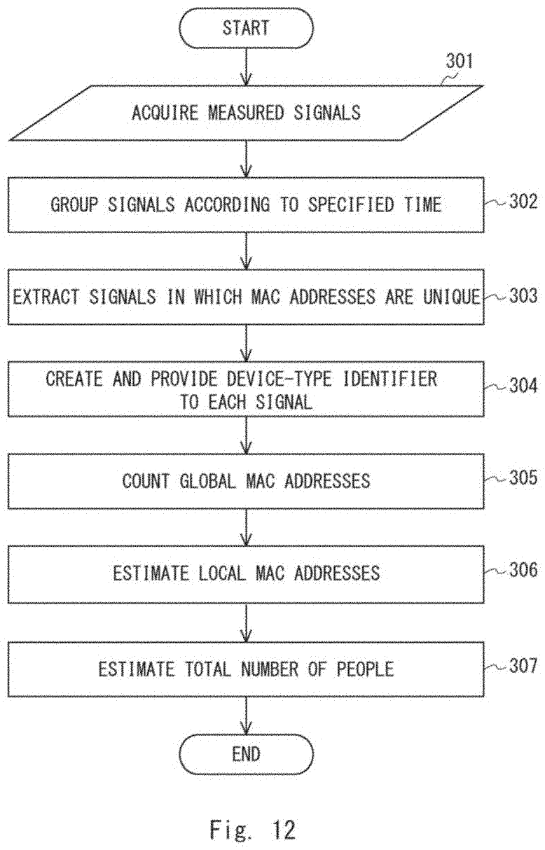

Next, a process for estimating the number of people performed by the analysis server 30 according to the third example embodiment will be described with reference to FIG. 12. FIG. 12 is a flowchart showing processes performed by the analysis server 30 according to the third example embodiment.

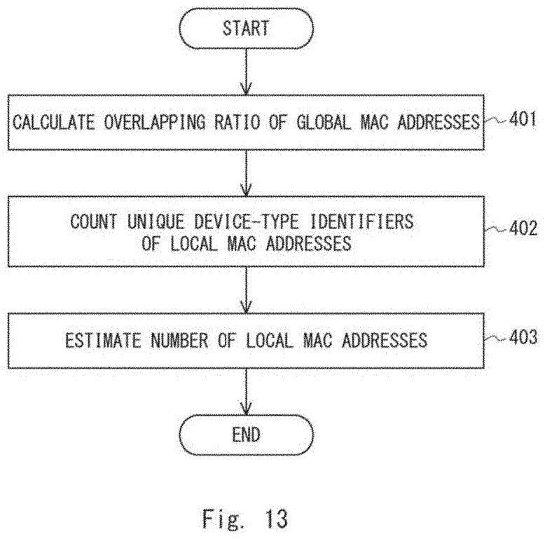

Firstly, the arithmetic unit 31 of the analysis server 30 acquires signals that were measured by the sensors 20 and are stored in the storage unit 32 (S301). Next, these signals are grouped according to the specified time (S302). Next, the arithmetic unit 31 extracts unique MAC addresses from each of the groups which have been formed according to the time (S303). Next, the arithmetic unit 31 creates, for each of the signals, a device-type identifier by connecting the values of designated fields in the frame, and provides (i.e., incorporates) the created device-type identifier to the signal (S304). Next, the arithmetic unit 31 analyzes, for each of the signals, a unique MAC address assigned to the terminal 10, extracts global MAC addresses, and counts the number of the extracted global MAC addresses (S305). Next, the arithmetic unit 31 estimates the number of terminals 10 to which local MAC addresses are assigned by using a method shown in FIG. 13 (which will be described later) (S306). Lastly, the arithmetic unit 31 estimates the total number of people by using the number of terminals 10 to which global MAC addresses are assigned and the number of terminals 10 to which local MAC addresses are assigned (S307).

Next, a process for estimating the number of terminals 10 to which local MAC addresses are assigned, performed by the analysis server 30 according to the third example embodiment will be described with reference to FIG. 13. FIG. 13 is a flowchart showing a method for estimating the number of terminals 10 to which local MAC addresses are assigned, performed by the analysis server 30 according to the third example embodiment. In the following descriptions, the device-type identifier of a terminal 10 to which a global MAC address is assigned will be referred to as a global device-type identifier, and the device-type identifier of a terminal 10 to which a local MAC address is assigned will be referred to as a local device-type identifier.

Firstly, the arithmetic unit 31 calculates an overlapping ratio a_{G} of global MAC addresses (S401). Specifically, the arithmetic unit 31 calculates the overlapping ratio a_{G} of global MAC addresses by dividing the number of unique global MAC addresses by the number of unique global device-type identifiers. Next, the arithmetic unit 31 counts local device-type identifiers (S402). Specifically, the arithmetic unit 31 counts the number of unique local device-type identifiers in the terminals 10 to which local MAC addresses are assigned. Lastly, the arithmetic unit 31 estimates the number of local MAC addresses (S403). Specifically, the arithmetic unit 31 estimates the number of terminals 10 to which local MAC addresses are assigned by multiplying the overlapping ratio a_{G} of global MAC addresses calculated in the process in the step S401 by the number T_{L} of local device-type identifiers calculates in the process in the step S402.

Note that the arithmetic unit 31 may calculate the overlapping ratio a_{G} of global MAC addresses every time data is summarized, or may continuously use the same calculated value for a certain period of time such as one hour, one day, or one week.

As described above, the arithmetic unit 31 of the analysis server 30 of the number-of-people estimation system 300 summarizes (i.e., collects) probe request signals received by the sensors 20, and creates device-type identifiers by connecting the values of fields included in the frames. The arithmetic unit 31 calculates an overlapping ratio in the group of terminals 10 to which global MAC addresses are assigned, and estimates the number of terminals 10 to which local MAC addresses are assigned by using the calculated value of the overlapping ratio. Then, the number-of-people estimation system 300 adds the aforementioned estimated number of terminals 10 to the number of terminals 10 including the global MAC addresses from which the aforementioned estimated number has been measured, and estimates the total number of people according to the Expression 8.

Note that the above-described example embodiment has been described on the assumption that signals transmitted from terminals 10 are probe request signals. In general, all the frames in conformity with the Wi-Fi standards include MAC addresses. Therefore, signals of other management frames, control frames, and signals of data frames can be used as objects to be measured for estimating the number of people in exactly the same manner. In such a case, since the frequency of transmission operations of such signals (i.e., how often such signals are transmitted) is different from that of probe request signals, it is necessary to change the length of the set time during which data is collected according to the type of the used signals.

### Fourth Example Embodiment

Next, a configuration of a number-of-people estimation system 400 according to a fourth example embodiment will be described. The configuration of the number-of-people estimation system 400 is identical to that of the number-of-people estimation system 200 according to the second example embodiment. The arithmetic unit 31 of the analysis server 30 of the number-of-people estimation system 400 performs calculation with smaller number of data by using an estimation method that is obtained by simplifying the estimation method according to the third example embodiment.

### <Method for Estimating Number of People>

Similarly to the number-of-people estimation system 300 according to the third example embodiment, the arithmetic unit 31 of the analysis server 30 of the number-of-people estimation system 400 measures signals of terminals 10. Then, the number-of-people estimation system 400 creates and provides device-type identifiers using the values of fields included in the measured signals.

Then, the arithmetic unit 31 sets an overlapping ratio a by using the above-shown Expression 3. Note that although the arithmetic unit 31 may calculate the overlapping ratio a for each time period during which data is collected, it preferably uses the same calculated value in a fixed manner for a certain period of time such as one hour, one day, or one week, so that the burden (i.e., the amount) of calculation is reduced.

The arithmetic unit 31 estimates the number N of people in the crowd G1 in the place of interest shown in FIG. 8 according to the Expression 6. Note that T is the number of unique device-type identifiers included in the signals measured by the sensors 20. Further, a parameter rₚ is a ratio of the number of people included in the terminal possessing group G3 to the number of people in the crowd G1 present in the place of interest. A parameter rₒₙ is a ratio of the number of terminals possessed by people included in the Wi-Fi-On group G5 to the number of terminals possessed by people included in the terminal possessing group G3.

$$N = \frac{1}{{r}_{p} \times {r}_{on}} aT \qquad [ Expression 9 ]$$

### <Process for Estimating Number of People>

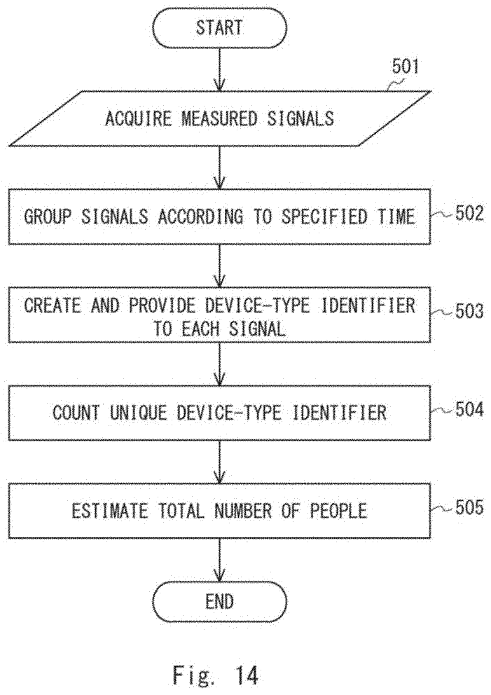

Next, processes performed by the analysis server 30 according to the fourth example embodiment will be described with reference to FIG. 14. FIG. 14 is a flowchart showing a process for estimating the number of people, performed by the analysis server 30 according to the fourth example embodiment.

Firstly, the arithmetic unit 31 of the analysis server 30 acquires signals which were measured by the sensors 20 and are stored in the storage unit 32 (S501). Next, these signals are grouped according to the specified time (S502). Next, the arithmetic unit 31 creates, for each of the signals, a device-type identifier by connecting the values of designated fields in the frame, and provides (i.e., incorporates) the created device-type identifier to the signal (S503). Next, the arithmetic unit 31 counts the number of these unique device-type identifiers (S504). Lastly, the arithmetic unit 31 estimates the total number of people according to the Expression 9 by using the counted number (S505).

As described above, the number-of-people estimation system 400 according to the fourth example embodiment does not make an analysis, for each signal, as to whether the MAC address included in the signal is a local MAC address or a global MAC address. Therefore, the number-of-people estimation system 400 can estimate the number of people with a smaller amount of computing resources such as a smaller amount of memory capacity and a shorter calculation time.

Note that the present disclosure is not limited to the above-described example embodiments and may be modified as appropriate without departing from the spirit and scope of the present disclosure.

While the invention has been particularly shown and described with reference to embodiments thereof, the invention is not limited to these embodiments. It will be understood by those of ordinary skill in the art that various changes in form and details may be made therein without departing from the spirit and scope of the present disclosure as defined by the claims.

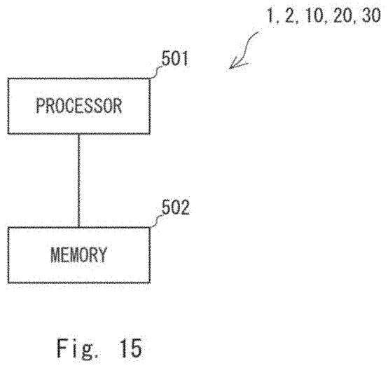

Next, an example of a hardware configuration of a computer related to the acquisition apparatus 1, the number-of-people estimation apparatus 2, the portable terminals 10, the sensor 20, and the analysis server 30 (i.e., related to each of the apparatuses) will be described with reference to FIG. 15. In FIG. 15, a computer includes a processor 501 and a memory 502. The processor 501 may be, for example, a microprocessor, an MPU (Micro Processing Unit), or a CPU (Central Processing Unit). The processor 501 may include a plurality of processors. The memory 502 is formed by a combination of a volatile memory and a nonvolatile memory. The memory 502 may include a storage remotely located from the processor 501. In such a case, the processor 501 may access the memory 502 through an I/O interface (not shown).

Further, each apparatus in the above-described example embodiments may be constructed by software, hardware, or both of them. Further, each apparatus may be constructed by one hardware device or one software program, or a plurality of hardware devices or a plurality of software programs. The function (the process) of each apparatus in the above-described example embodiments may be implemented by a computer. For example, a program for causing the computer to perform a method according to an example embodiment may be stored in the memory 502, and each function may be implemented by having the processor 501 execute the program stored in the memory 502.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The whole or part of the exemplary embodiments disclosed above can be described as, but not limited to, the following supplementary notes.

(Supplementary Note 1)

A system for estimating the number of people comprising:

an acquisition apparatus configured to acquire signals transmitted from terminals; and

an apparatus for estimating the number of people configured to estimate the number of people by using the signals, wherein

the apparatus for estimating the number of people comprises at least one memory configured to store an instruction and at least one processor configured to execute the instruction, the memory and the processor being configured to:

group the signals acquired within a predetermined time; extract first identifiers of the terminals from the signals included in the group;

classify the first identifiers into first identifiers assigned to a global network and those assigned to a local network;

count the first identifiers assigned to the global network; and

estimate the number of people by using the number of the first identifiers assigned to the global network.

(Supplementary Note 2)

The system for estimating the number of people described in Supplementary note 1, wherein the estimating the number of people comprises estimating the number of terminals having the first identifiers assigned to the local network by using the number of the first identifiers assigned to the global network.

(Supplementary Note 3)

A system for estimating the number of people comprising:

an acquisition apparatus configured to acquire signals transmitted from terminals; and

an apparatus for estimating the number of people configured to estimate the number of people by using the signals, wherein

the apparatus for estimating the number of people comprises at least one memory configured to store an instruction and at least one processor configured to execute the instruction, the memory and the processor being configured to:

group the signals acquired within a predetermined time;

create second identifiers for the signals included in the group by using a plurality of values included in the signals;

count the second identifiers; and

estimate the number of people possessing the terminals based on the number of second identifiers, and

the plurality of values included in the signals are values that are selected in advance as those whose changes within the predetermined time are equal to or smaller than a predetermined value.

(Supplementary Note 4)

A system for estimating the number of people comprising:

an acquisition apparatus configured to acquire signals transmitted from terminals; and

an apparatus for estimating the number of people configured to estimate the number of people by using the signals, wherein

the apparatus for estimating the number of people comprises at least one memory configured to store an instruction and at least one processor configured to execute the instruction, the memory and the processor being configured to:

group the signals acquired within a predetermined time;

extract unique first identifiers of the terminals from the signals included in the group;

create second identifiers for the signals included in the group by using a plurality of values included in the signals;

classify the first identifiers into first identifiers assigned to a global network and those assigned to a local network;

count the first identifiers assigned to a global network and unique second identifiers; and

estimate the number of terminals having the first identifiers assigned to the local network by using the number of the first identifiers assigned to the global network and the number of the second identifiers, and estimate the number of people by using the number of the first identifiers assigned to the global network and the number of the terminals having the first identifiers assigned to the local network, and

the plurality of values included in the signals are values that are selected in advance as those whose changes within the predetermined time are equal to or smaller than a predetermined value.

(Supplementary Note 5)

The system for estimating the number of people described in Supplementary note 4, wherein the estimating the number of people comprises calculating a ratio of the number of terminals having the first identifiers assigned to the global network to the number of the second identifiers assigned to the global network, and estimating the number of terminals having the first identifiers assigned to the local network by using the calculated ratio and the number of the second identifiers assigned to the local network.

(Supplementary Note 6)

The system for estimating the number of people described in any one of Supplementary notes 3 to 5, wherein a value included in the signal used to create the second identifier includes a value of a field included in a Frame Body of a Wi-Fi frame.

(Supplementary Note 7)

The system for estimating the number of people described in any one of Supplementary Notes 1 to 6, wherein the terminal is a portable terminal in conformity with IEEE802.11 standards.

(Supplementary Note 8)

The system for estimating the number of people described in any one of Supplementary notes 1 to 7, wherein the first identifier is a MAC address.

(Supplementary Note 9)

The system for estimating the number of people described in any one of Supplementary notes 1 to 8, wherein the signal transmitted from the terminal is a probe request signal.

(Supplementary Note 10)

The system for estimating the number of people described in any one of Supplementary notes 1 to 9, wherein a parameter used in a predetermined mathematical expression is changed according to a region, a place, and a time at which measurement is performed by a sensor.

(Supplementary Note 11)

An apparatus for estimating the number of people comprising at least one memory configured to store an instruction and at least one processor configured to execute the instruction, the memory and the processor being configured to:

group signals of terminals acquired within a predetermined time;

extract first identifiers of the terminals from the signals included in the group;

classify the first identifiers into first identifiers assigned to a global network and those assigned to a local network;

count the first identifiers assigned to the global network; and

estimate the number of people by using the number of the first identifiers assigned to the global network.

(Supplementary Note 12)

The apparatus for estimating the number of people described in Supplementary note 11, wherein the estimating the number of people comprises estimating the number of terminals having the first identifiers assigned to the local network by using the number of the first identifiers assigned to the global network.

(Supplementary Note 13)

An apparatus for estimating the number of people comprising at least one memory configured to store an instruction and at least one processor configured to execute the instruction, the memory and the processor being configured to:

group signals of terminals acquired within a predetermined time;

extract unique first identifiers of the terminals from the signals included in the group;

create second identifiers for the signals included in the group by using a plurality of values included in the signals;

classify the first identifiers into first identifiers assigned to a global network and those assigned to a local network;

count the first identifiers assigned to a global network and unique second identifiers; and

estimate the number of terminals having the first identifiers assigned to the local network by using the number of the first identifiers assigned to the global network and the number of the second identifiers, and estimate the number of people by using the number of the first identifiers assigned to the global network and the number of the terminals having the first identifiers assigned to the local network, wherein

the plurality of values included in the signals are values that are selected in advance as those whose changes within the predetermined time are equal to or smaller than a predetermined value.

(Supplementary Note 14)

The apparatus for estimating the number of people described in Supplementary note 13, wherein the estimating the number of people comprises calculating a ratio of the number of terminals having the first identifiers assigned to the global network to the number of the second identifiers assigned to the global network, and estimating the number of terminals having the first identifiers assigned to the local network by using the calculated ratio and the number of the second identifiers assigned to the local network.

(Supplementary Note 15)

The apparatus for estimating the number of people described in Supplementary note 13 or 14, wherein a value included in the signal used to create the second identifier includes a value of a field included in a Frame Body of a Wi-Fi frame.

(Supplementary Note 16)

The apparatus for estimating the number of people described in any one of Supplementary notes 11 to 15, wherein the first identifier is a MAC address.

(Supplementary Note 17)

The apparatus for estimating the number of people described in any one of Supplementary notes 11 to 16, wherein the terminal is a portable terminal in conformity with IEEE802.11 standards.

(Supplementary Note 18)

An apparatus for estimating the number of people comprising at least one memory configured to store an instruction and at least one processor configured to execute the instruction, the memory and the processor being configured to:

group signals of terminals acquired within a predetermined time;

create second identifiers for the signals included in the group by using a plurality of values included in the signals;

count the second identifiers; and

estimate the number of people possessing the terminals based on the number of second identifiers, wherein

the plurality of values included in the signals are values that are selected in advance as those whose changes within the predetermined time are equal to or smaller than a predetermined value.

(Supplementary Note 19)

A method for estimating the number of people comprising:

grouping signals of terminals acquired within a predetermined time;

extracting first identifiers of the terminals from the signals included in the group;

classifying the first identifiers into first identifiers assigned to a global network and those assigned to a local network;

counting the first identifiers assigned to the global network; and

estimating the number of people by using the number of the first identifiers assigned to the global network.

(Supplementary Note 20)

A method for estimating the number of people comprising:

grouping signals of terminals acquired within a predetermined time;

creating second identifiers for the signals included in the group by using a plurality of values included in the signals;

counting the second identifiers; and

estimating the number of people possessing the terminals based on the number of second identifiers, wherein

the plurality of values included in the signals are values that are selected in advance as those whose changes within the predetermined time are equal to or smaller than a predetermined value.

(Supplementary Note 21)

A method for estimating the number of people comprising:

grouping signals of terminals acquired within a predetermined time;

extracting unique first identifiers of the terminals from the signals included in the group;

creating second identifiers for the signals included in the group by using a plurality of values included in the signals;

classifying the first identifiers into first identifiers assigned to a global network and those assigned to a local network;

counting the first identifiers assigned to a global network and unique second identifiers; and

estimating the number of terminals having the first identifiers assigned to the local network by using the number of the first identifiers assigned to the global network and the number of the second identifiers, and estimating the number of people by using the number of the first identifiers assigned to the global network and the number of the terminals having the first identifiers assigned to the local network, wherein

the plurality of values included in the signals are values that are selected in advance as those whose changes within the predetermined time are equal to or smaller than a predetermined value.

(Supplementary Note 22)

A non-transitory computer readable medium storing a program for causing a computer to perform:

a process for grouping signals of terminals acquired within a predetermined time;

a process for extracting first identifiers of the terminals from the signals included in the group;

a process for classifying the first identifiers into first identifiers assigned to a global network and those assigned to a local network;

a process for counting the first identifiers assigned to the global network; and

a process for estimating the number of people by using the number of the first identifiers assigned to the global network.

(Supplementary Note 23)

A non-transitory computer readable medium storing a program for causing a computer to perform:

a process for grouping signals of terminals acquired within a predetermined time;

a process for creating second identifiers for the signals included in the group by using a plurality of values included in the signals;

a process for counting the second identifiers; and

a process for estimating the number of people possessing the terminals based on the number of second identifiers, wherein

the plurality of values included in the signals are values that are selected in advance as those whose changes within the predetermined time are equal to or smaller than a predetermined value.

(Supplementary Note 24)

A non-transitory computer readable medium storing a program for causing a computer to perform:

a process for grouping signals of terminals acquired within a predetermined time;

a process for extracting unique first identifiers of the terminals from the signals included in the group;

a process for creating second identifiers for the signals included in the group by using a plurality of values included in the signals;

a process for classifying the first identifiers into first identifiers assigned to a global network and those assigned to a local network;

a process for counting the first identifiers assigned to a global network and unique second identifiers; and

a process for estimating the number of terminals having the first identifiers assigned to the local network by using the number of the first identifiers assigned to the global network and the number of the second identifiers, and estimating the number of people by using the number of the first identifiers assigned to the global network and the number of the terminals having the first identifiers assigned to the local network, wherein

the plurality of values included in the signals are values that are selected in advance as those whose changes within the predetermined time are equal to or smaller than a predetermined value.

According to the present disclosure, it is possible to provide an apparatus for estimating the number of people and a method for estimating the number of people capable of accurately estimating the number of people.

1. An apparatus for estimating the number of people comprising at least one memory configured to store an instruction and at least one processor configured to execute the instruction, the memory and the processor being configured to:
group signals of terminals acquired within a predetermined time;
extract first identifiers of the terminals from the signals included in the group;
classify the first identifiers into first identifiers assigned to a global network and those assigned to a local network;
count the first identifiers assigned to the global network; and
estimate the number of people by using the number of the first identifiers assigned to the global network.

2. The apparatus for estimating the number of people according to claim 1, wherein the estimating the number of people comprises estimating the number of terminals having the first identifiers assigned to the local network by using the number of the first identifiers assigned to the global network.

3. An apparatus for estimating the number of people comprising at least one memory configured to store an instruction and at least one processor configured to execute the instruction, the memory and the processor being configured to:
group signals of terminals acquired within a predetermined time;
extract unique first identifiers of the terminals from the signals included in the group;
create second identifiers for the signals included in the group by using a plurality of values included in the signals;
classify the first identifiers into first identifiers assigned to a global network and those assigned to a local network;
count the first identifiers assigned to a global network and unique second identifiers; and
estimate the number of terminals having the first identifiers assigned to the local network by using the number of the first identifiers assigned to the global network and the number of the second identifiers, and estimate the number of people by using the number of the first identifiers assigned to the global network and the number of the terminals having the first identifiers assigned to the local network, wherein
the plurality of values included in the signals are values that are selected in advance as those whose changes within the predetermined time are equal to or smaller than a predetermined value.

4. The apparatus for estimating the number of people according to claim 3, wherein the estimating the number of people comprises calculating a ratio of the number of terminals having the first identifiers assigned to the global network to the number of the second identifiers assigned to the global network, and estimating the number of terminals having the first identifiers assigned to the local network by using the calculated ratio and the number of the second identifiers assigned to the local network.

5. The apparatus for estimating the number of people according to claim 3, wherein a value included in the signal used to create the second identifier includes a value of a field included in a Frame Body of a Wi-Fi frame.

6. The apparatus for estimating the number of people according to claim 3, wherein the first identifier is a MAC address.

7. The apparatus for estimating the number of people according to claim 3, wherein the terminal is a portable terminal in conformity with IEEE802.11 standards.

8. A method for estimating the number of people comprising:
grouping signals of terminals acquired within a predetermined time;
extracting first identifiers of the terminals from the signals included in the group;
classifying the first identifiers into first identifiers assigned to a global network and those assigned to a local network;
counting the first identifiers assigned to the global network; and
estimating the number of people by using the number of the first identifiers assigned to the global network.
